(19) United States
(12) Patent Application Publication
(10) Pub. No.: US 2025/0334751 A1
(43) Pub. Date: Oct. 30, 2025

(54) CRIMP BAND FOR CONNECTOR AND CABLE ASSEMBLY PROCESS

(71) Applicant: CORNING RESEARCH & DEVELOPMENT CORPORATION, Corning, NY (US)

(72) Inventors: Joshua D. Hitzemann, Lenoir, NC (US); David Wayne Howard, Granite Falls, NC (US)

(21) Appl. No.: 19/184,023

(22) Filed: Apr. 21, 2025

Related U.S. Application Data
(60) Provisional application No. 63/639,839, filed on Apr. 29, 2024.
(60) Provisional application No. 63/779,573, filed on Mar. 28, 2025.

(51) Int. Cl. G02B 6/38; G02B 6/44

(52) U.S. Cl. CPC G02B 6/3857; G02B 6/4479; G02B 6/3887

(57) ABSTRACT

A crimp band is provided with a first portion configured to be received over a rear portion of a connector body. The first portion is shaped to have an interference fit with the rear portion of the connector body when the first portion is received thereon. Methods of forming a cable assembly with such a crimp band involve initially securing a cable to the connector with the crimp band, completing at least one additional processing step with the cable initially secured by the crimp band, completing a re-work of the additional processing step(s) with the crimp band removed from the connector, and later permanently securing the cable to the connector with the crimp band.

### PRIORITY

This application claims the benefit of priority of U.S. Provisional Application No. 63/779,573, filed on Mar. 28, 2025, and U.S. Provisional Application No. 63/639,839, filed on Apr. 29, 2024, both applications being incorporated herein by reference.

### TECHNICAL FIELD

This disclosure relates generally to connectors for telecommunications networks, and more particularly to a new crimp band for fiber optic connectors and methods of making a fiber optic cable assembly using crimp bands according to this disclosure.

### BACKGROUND

Optical fibers are useful in a wide variety of applications, including the telecommunications industry for voice, video, and data transmissions. In a telecommunications system that uses optical fibers, there are typically many locations where fiber optic cables that carry the optical fibers connect to equipment or other fiber optic cables. To conveniently provide these connections, fiber optic connectors are often assembled onto the ends of fiber optic cables to form a cable assembly. The cable assembly manufacturing process is sometimes referred to as a termination or “connectorization” process because the process results in the fiber optic connectors terminating the optical fiber(s) carried by the fiber optic cable.

A cable assembly manufacturing process involves several steps, including mechanically coupling the cable to the connector. For many connectors, this coupling step includes crimping strength members of the cable, such as aramid yarn, to a portion of the connector using a crimp band (also referred to as a crimp ring). This typically occurs after terminating the optical fiber(s) of the cable with a ferrule of the connector (or two ferrules in the event of a duplex connector), and after connector body components are assembled together with the terminated ferrule. Before crimping, the strength members are flared over a rear portion of the connector body. The crimp band, which is slid onto the cable before the terminating and assembling steps, is then advanced over the fared-out strength members and rear portion of the connector body. The crimp band has an internal shape that is oversized relative to the portion of the connector body over which the crimp band is positioned, which allows for easy installation of the crimp band. Once positioned, the crimp band is then crimped to permanently secure the strength members (and, therefore, the fiber optic cable) to the connector.

Crimping has proven to be an effective way for securing fiber optic cables to fiber optic connectors for many years, allowing the connectors to remain attached when experiencing loads relative to the cable during use. However, crimping can present some challenges during the manufacturing of a cable assembly. For example, crimping is typically an irreversible process that can make “re-work” steps, such as re-polishing or re-configuring connector components (e.g., adding or removing guide pins in multifiber connectors), challenging or even impossible. The need for re-work steps is often not discovered until the end of the cable assembly manufacturing process when inspection and testing steps are performed. If a re-work step is required after crimping, a technician may be forced to cut the connector off the cable and start a new termination process.

Accordingly, there exists a need for an improved cable assembly manufacturing process that addresses these and other deficiencies of traditional processes.

### SUMMARY

The present disclosure provides a crimp band that is configured to have an interference fit with a rear portion of a connector. The interference fit allows the crimp band to be used to initially secure a telecommunications cable, such as a fiber optic cable or a copper cable, to a connector without being crimped. This has advantages for cable assembly manufacturing processes. Certain steps can be performed prior to the initial securing, and one or more additional steps can then be performed while the crimp band keeps the cable initially secured to the connector. The initial securing provides less retention compared to permanent securing (i.e., the type of securing intended to be irreversible). If at least one of the additional processing steps requires a re-work (i.e., repeat or correction), the initial coupling between the cable and the connector that is provided by the crimp band can be released to allow the re-work to be performed more easily.

According to one aspect of this disclosure, a method of making a fiber optic cable assembly from a cable and a connector is disclosed. The cable includes a cable jacket, at least one optical fiber carried within the cable jacket, and aramid yarn carried within the cable jacket. The connector includes a ferrule and a connector body. The method comprises: positioning a crimp band over an end portion of the cable jacket; terminating the at least one optical fiber with the ferrule after positioning the crimp band, wherein the at least one optical fiber extends from an end of the cable jacket before the terminating; assembling the connector body with the ferrule before or after the terminating step; positioning at least some length of aramid yarn that extends from the end of the cable jacket over a rear portion of the connector body; and moving the crimp band over the rear portion of the connector body after the preceding steps such that the at least some length of the aramid yarn is positioned between the crimp band and the rear portion of the connector body. The crimp band is configured to have an interference fit with the rear portion of the connector body without being crimped such that the moving results in the crimp band securing the at least some length of aramid yarn to the rear portion of the connector body. The method further comprises: performing one or more additional processing steps while the at least some length of aramid yarn remains secured to the rear portion of the connector body by the interference fit with the crimp band; determining that a re-work of the assembling step or any of the one or more additional processing steps is needed before crimping the crimp band over the rear portion of the connector body; removing the crimp band from the rear portion of the connector body and performing the re-work; and crimping the crimp band over the rear portion of the connector body after performing the re-work.

According to a further aspect or embodiment, the method described in the preceding paragraph may further comprise coupling a positioning tool to the connector body after the moving step results in the crimp band securing the at least some length of aramid yarn to the rear portion of the connector body. The positioning tool may be configured to interface with test equipment and/or equipment used to perform the one or more additional processing steps. In some embodiments, the positioning tool may define a latch member that is positioned over a top side of the connector body when the positioning tool is coupled to the connector body. In some embodiments, the step of removing the crimp band further comprises moving the positioning tool away from the connector body such that the positioning tool decouples from the connector body. The positioning tool in such embodiments may be configured to cause the crimp band to move with the positioning tool away from the connector body.

According to some embodiments of the method described above, the one or more additional processing steps comprises polishing an end face of the ferrule, and the re-work comprises re-polishing the end face of the ferrule. Alternatively or additionally, the re-work may comprise: disassembling the connector at least partially; changing a gender configuration of the ferrule by adding or removing one or more guide pins that are each configured to extend through the ferrule; and re-assembling the connector.

Additionally, in some embodiments of methods according to this disclosure, the crimp band may include a passage extending therethrough and a first portion configured to provide the interference fit with the rear portion of the connector body. The passage defines a minimum inner width in the first portion that is between about 0.25 mm and about 0.75 mm less than a maximum outer width of the rear portion of the connector body. In some embodiments, the crimp band may be tubular and include one or more radially-inward projections configured to provide the interference fit with the rear portion of the connector body. For example, the one or more radially-inward projections may comprise a radially-inward, annular projection at a location along a length of the crimp band.

According to another aspect of this disclosure, other methods of making a fiber optic cable assembly from a cable and a connector are disclosed, wherein the cable includes a cable jacket, at least one optical fiber carried within the cable jacket, and aramid yarn carried within the cable jacket, and wherein the connector includes a ferrule and a connector body. One such other method comprises: positioning a crimp band over an end portion of the cable jacket; securing the at least one optical fiber to the ferrule after positioning the crimp band, wherein the at least one optical fiber extends from an end of the cable jacket before the securing; assembling the connector body with the ferrule before or after the securing step; positioning at least some length of aramid yarn that extends from the end of the cable jacket over a rear portion of the connector body; and moving the crimp band over the rear portion of the connector body after the preceding steps such that the at least some length of aramid yarn is positioned between the crimp band and the rear portion of the connector body. The crimp band is configured to have an interference fit with the rear portion of the connector body without being crimped such that the moving results in the crimp band securing the at least some length of aramid yarn to the rear portion of the connector body. The method further comprises: inspecting the connector while the at least some length of aramid yarn remains secured to the rear portion of the connector body by the interference fit with the crimp band; identifying that one or more additional processing steps or assembly steps is required based on the inspecting; removing the crimp band from the rear portion of the connector body and performing the one or more additional processing steps or assembly steps that were identified; and crimping the crimp band over the rear portion of the connector body after performing the one or more additional processing steps or assembly steps that were identified.

According to another aspect of this disclosure, methods of making a telecommunications cable assembly from a cable and a connector are disclosed, wherein the cable carries at least one signal conductor. One such method comprises: positioning a crimp band over a cable jacket of the cable; and terminating the at least one signal conductor with the connector, wherein the crimp band is spaced from the connector during the terminating, and wherein an end section of the at least one signal conductor extends from an end of the cable jacket before the terminating. The method further comprises: positioning at least some amount of strength members of the cable over a rear portion of the connector; and moving at least a first portion of the crimp band over the rear portion of the connector after the terminating step and after the step of positioning at least some amount of the strength members. The first portion of the crimp band is configured to have an interference fit with the rear portion of the connector without being crimped such that the moving results in the crimp band initially securing the at least some amount of the strength members to the connector. The method also comprises: performing one or more additional processing steps while the crimp band remains uncrimped and the cable remains initially secured to the connector by the crimp band; determining that a re-work of at least one of the one or more processing steps is required; removing the crimp band from the connector so that the cable is no longer initially secured to the connector; performing the re-work; and permanently securing the cable to the connector using the crimp band, wherein the crimp band is crimped to permanently secure the cable to the connector.

Additional features and advantages will be set out in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a perspective view of one example of a fiber optic cable assembly that includes a fiber optic connector installed on the end of a fiber optic cable.

FIG. 2 is a side view of components of the fiber optic cable assembly of FIG. 1 before securing the end of the fiber optic cable to a rear portion of a connector body of the fiber optic connector.

FIG. 3 is a side view illustrating an example of a conventional crimp band over the rear portion of the connector body of the fiber optic connector of FIG. 1.

FIG. 4 is a side view illustrating an example of a crimp band according to this disclosure over the rear portion of the connector body of the fiber optic connector of FIG. 1.

FIGS. 5-8 are side views illustrating steps of an example method for securing the fiber optic cable of FIG. 1 to the fiber optic connector using the crimp band of FIG. 4.

FIG. 9 is a perspective view a crimp band according to another embodiment of this disclosure.

FIG. 10 is a cross-sectional side view of the crimp band of FIG. 9 received over the rear portion of the connector body of the fiber optic connector of FIG. 1.

FIGS. 11 is a perspective view a crimp band according to yet another embodiment of this disclosure.

FIGS. 12 and 13 are respective side and cross-sectional views of a crimp band according to yet another embodiment of this disclosure.

FIG. 14 is a perspective view of one embodiment of a positioning tool according to this disclosure.

FIG. 15 is an exploded perspective view of the positioning tool of FIG. 14.

FIG. 16 is another exploded perspective view of the positioning tool of FIG. 14.

FIGS. 17 and 18 are perspective views of the positioning tool of FIG. 15 being coupled to the connector body of the fiber optic connector of FIG. 1, wherein some components of the positioning tool are hidden to better view the coupling.

FIG. 19 is a perspective view similar to FIG. 18, but with a latch body of the positioning tool now being shown.

FIG. 20 is a perspective view similar to FIG. 19, but with an extension member of the positioning tool now being shown.

FIG. 21 is a perspective view of the fiber optic connector of FIG. 1 after securing the cable to the fiber optic connector, and with a boot of the fiber optic connector positioned over the cable.

FIG. 22 is a perspective view similar to FIG. 21, but with the boot moved forward to couple to the connector body of the fiber optic connector, wherein the boot covers the interface between the connector body and the cable.

### DETAILED DESCRIPTION

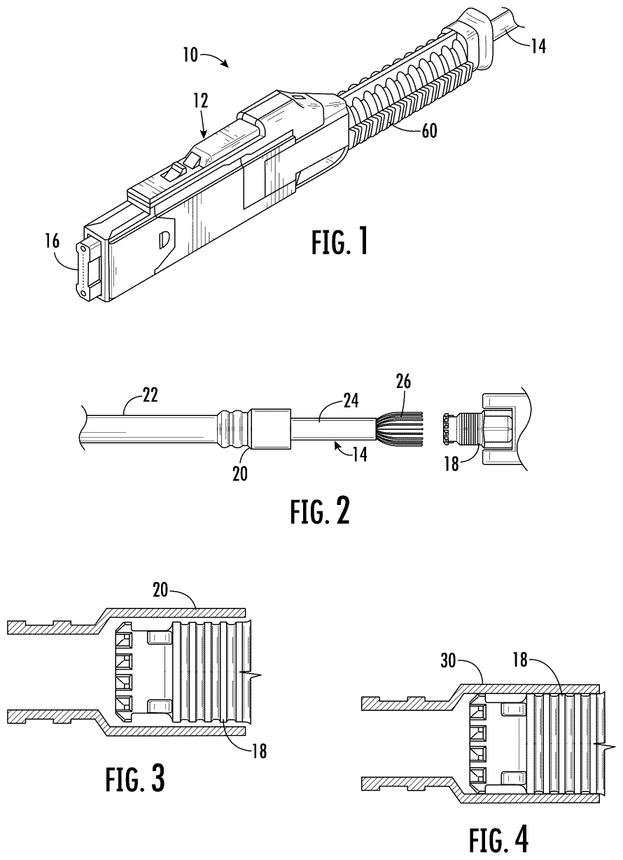

Various embodiments will be further clarified by examples in the description below. First, to provide additional context for embodiments of this disclosure, FIGS. 1 and 2 show a conventional arrangement of an optical cable assembly 10 with a fiber optic connector (“connector 12”) secured to an end of a fiber optic cable 14 (“cable 14”). The connector 12 includes a ferrule 16 supported and/or at least partially retained in a connector body 18, which may comprise multiple body components secured together. A boot 60, which may also comprise multiple components (and be referred to as a strain relief assembly 60) or be a single component, couples to the connector body 18 and covers an interface between the cable 14 and the connector body 18. Although the connector 12 is shown in the form of an MMC connector, which is a very small form factor (VSFF) multifiber connector available from US Conec, Ltd., the present disclosure may apply to other connector types, including single-fiber (simplex), dual-fiber (duplex), and multifiber connector types which may or may not be the subject of industry standards.

As shown in FIG. 2, a crimp band 20 (also referred to as a “crimp ring”) of the connector 12 is typically slid onto an end portion of the cable 14 before securing the connector 12 to the cable 14. A heat shrink tube 22 may also be slid onto the end portion of the cable 14 in a similar manner. Although not shown in FIG. 2, the boot 60 (FIG. 1) may be slid onto the end portion of the cable 14 before the crimp band 20 and heat shrink tube 22. The cable 14 itself includes a cable jacket 24, strength members 26 (e.g., aramid yarn), and optical fibers (not shown in FIG. 2 to simplify the drawing) carried within the cable jacket 24. During the process of installing the connector 12 onto the cable 14, the end of the cable 14 is prepared so that a certain length of the optical fibers and a certain length of the strength members 26 extend beyond an end of the cable jacket 24. After terminating the optical fibers with the ferrule 16 (FIG. 1) and assembling the ferrule 16 with the connector body 18, the cable 14 is secured to a rear portion of the connector body 18 in the manner described in the Background section above. In particular, at least some length of the strength members 26 that extends from the end of the cable jacket 24 is positioned over the rear portion of the connector body 18. The crimp band 20 is then slid forward along the cable jacket 24 to have at least a first portion of the crimp band 20 eventually extend over the rear portion of the connector body 18 and the strength members 26 that were positioned over the rear portion of the connector body 18. The crimp band 20 (or at least the first portion thereof) can then be crimped to secure the strength members 26 to the rear portion of the connector body 18, which effectively secures the cable 14 to the connector 12. Eventually the boot 60 is moved forward from the cable 14 and coupled to the connector body 18.

FIG. 3 shows how in conventional configurations, including the fiber optic cable assembly 10, the first portion of the crimp band 20 that is positioned over the rear portion of the connector body 18 is tubular and designed to be oversized relative to the rear portion of the connector body 18. For example, the first portion of the crimp band 20 may be cylindrical and have a minimum inner diameter that is greater than a maximum outer diameter of the rear portion of the connector body 18, which may also be cylindrical. This results in a clearance/gap between the components, as annotated in FIG. 3. As mentioned in the preceding paragraph, at least some length of the strength members 26 (FIG. 2) are positioned in the gap prior to crimping. Despite the strength members 26 occupying or even substantially filling the gap, the crimp band 20 can easily fall off the rear portion of the connector body 18. This is why the crimp band 20 is typically crimped immediately after being moved into position over the rear portion of the connector body 18 to secure the connection between the cable 14 and the connector 12.

In contrast to FIG. 3, FIG. 4 schematically illustrates how a crimp band 30 according to this disclosure includes a first portion that is designed to have an interference fit with the rear portion of the connector body 18 prior to crimping. In other words, the first portion of the crimp band 30 has at least some region(s) where an inner shape/width is smaller or less than an outer shape/width of the rear portion of the connector body 18. The first portion of the crimp band 30 and/or the rear portion of the connector body 18 deforms slightly when positioning the first portion on the rear portion due to the interference. The result of the interference is a frictional force or resistance, which can be advantageous for a cable assembly manufacturing process. Such a process will be described first below before describing additional details of the crimp band 30 and example variations according to this disclosure.

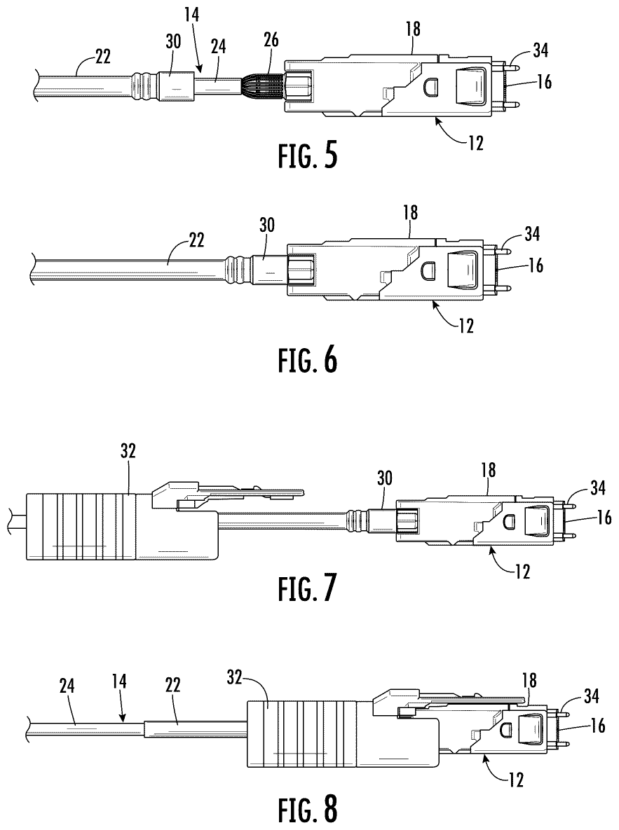

To this end, FIGS. 5-8 illustrate example steps that may be performed during the cable assembly manufacturing process. As shown in FIG. 5, the crimp band 30 may be slid onto or otherwise positioned over an end portion the cable jacket 24. Although not shown, the boot 60 (FIG. 1) may also be slid onto the cable 14 before the crimp band 30. These initial steps may occur before terminating the optical fibers of the cable 14 with the ferrule 16 and assembling the ferrule 16 with the connector body 18, similar to conventional configurations and cable assembly processes. Terminating with the ferrule 16 includes securing the optical fibers to the ferrule 16. In this disclosure, terminating with the connector 12 refers collectively to such securing and, if not already done before such securing, assembling the ferrule 16 with the connector body 18. After positioning at least some amount of the strength members 26 over the rear portion of the connector body 18, the crimp band 30 and heat shrink tube 22 (if present) may then be moved forward toward the connector 12 to result in the arrangement shown in FIG. 6. Interference between the rear portion of the connector body 18 and first portion of the crimp band 30 may be overcome with sufficient axial force to allow moving the crimp band 30 over the rear portion of the connector body 18. Optionally, and as shown in FIGS. 7 and 8, a positioning tool 32 may be used to assist with moving the crimp band 30 into position and thereby overcoming the interference with the rear portion of the connector body 18. The positioning tool 32 may have a U-shaped body or similar configuration so that the positioning tool 32 can be placed over the cable 14 from a side of the cable 14. The positioning tool 32 may be configured to removably couple to the connector body 18 and remain with the connector body 18 during subsequent processing steps. However, in other embodiments, the positioning tool 32 may not couple to the connector body 18 and be removed after advancing the crimp band 30 into position.

As a result of the frictional fit between the first portion of the crimp band 30 and the rear portion of the connector body 18, the strength members 26 become mechanically locked to the connector 12. The crimp band 30 can be designed so that the mechanical coupling at this point is sufficient to keep the strength members 26 (and, therefore, cable 14) secured to the connector 12 during subsequent processing steps. Such steps may include, for example, any one or more of the following: cleaving excess length of optical fibers that protrude from the ferrule 16, polishing the end face of the ferrule 16 and optical fibers, and inspecting the connector 12. The term “inspecting” is used in a general sense in this disclosure and may include visually inspecting the connector 12 (especially the end face of the ferrule 16) and/or testing the cable assembly 10 for insertion loss or other performance attributes. The inspection may be done using appropriate test equipment. Even if the mechanical coupling by the crimp band 30 is not as strong as if the crimp band 30 were crimped onto the rear portion of the connector body 18, in embodiments where the positioning tool 32 is used and is configured to couple the connector body 18, the latter coupling may further assist keeping the crimp band 30 on the rear portion of the connector body 18 during subsequent processing steps.

Inspection of the connector 12 may result in a technician and/or machine determining that one of the processing steps needs to be repeated or corrected (a “re-work”). For example, the end face of the ferrule 16 may not have the desired final geometry such that it is necessary to re-polish the ferrule 16. As another example, inspection may identify a gender configuration of the connector 12 being incorrect. The gender configuration may be based on whether guide pins 34 have been inserted through the ferrule 16 to project therefrom, as is well-known for various connector designs (including MMC connectors and MPO connectors). If guide pins 34 are not present (female configuration) but should be because a male configuration is intended for the connector 12, it may be necessary to at least partially dissemble the connector 12 to allow for insertion of the guide pins 34 through the ferrule 16. Similarly, if guide pins 34 were initially installed (male configuration) but should not have been because a female configuration is intended for the connector 12, it may be necessary to at least partially disassemble the connector 12 to allow for removal of the guide pins 34.

In the event a re-work is required, the technician and/or a machine may: (i) de-couple the positioning tool 32 (if present) from the connector body 18; and (ii) apply sufficient axial force to overcome the mechanical coupling (e.g., frictional engagement) between the crimp band 30 and rear portion of the connector body 18. In some embodiments, the positioning tool 32 may even be configured to assist with moving the crimp band 30 off the rear portion of the connector body 18 and back onto the cable jacket 24. With the crimp band 30 no longer providing a coupling between the cable 14 and the connector body 18, it may be possible to perform the re-work more easily. For example, it may be easier to position the connector 12 and/or interface the connector 12 with processing equipment (e.g., polishing equipment) without having the cable 14 coupled to the connector 12. Alternatively or additionally, without the crimp band 30 securing the cable 14 to the connector body 18, the optical fibers may be less likely to be pulled from the cable 14 or connector 12 during the re-work in a way that might result in unacceptable loss (when in use as a final cable assembly) due to bends, flaws, or other conditions introduced affecting performance. As mentioned above, some re-work steps may involve at least partially disassembling the connector 12, so not having the crimp band 30 securing the cable 14 to the connector body 18 during the re-work step may provide more freedom to move components around as needed and eventually reassemble the connector 12.

Once the re-work is completed, the crimp band 30 can once again be positioned onto the rear portion of the connector body 18 in the manner described above. And once subsequent processing steps are determined to be acceptable or complete (e.g., by way of further inspection/testing), a crimping step may be performed to permanently secure the crimp band 30 to the connector body 18. Such a crimping step may be done manually (e.g., with an appropriate tool) or by using automation equipment. Indeed, the crimping step may be completed in any known manner. The connection is permanent in the sense that the connection is not intended to be reversible. In the event a re-work step is needed after crimping, the connector 12 must typically be cut off from the cable 14 and thrown away, resulting in the need to start a new termination process with a new connector 12.

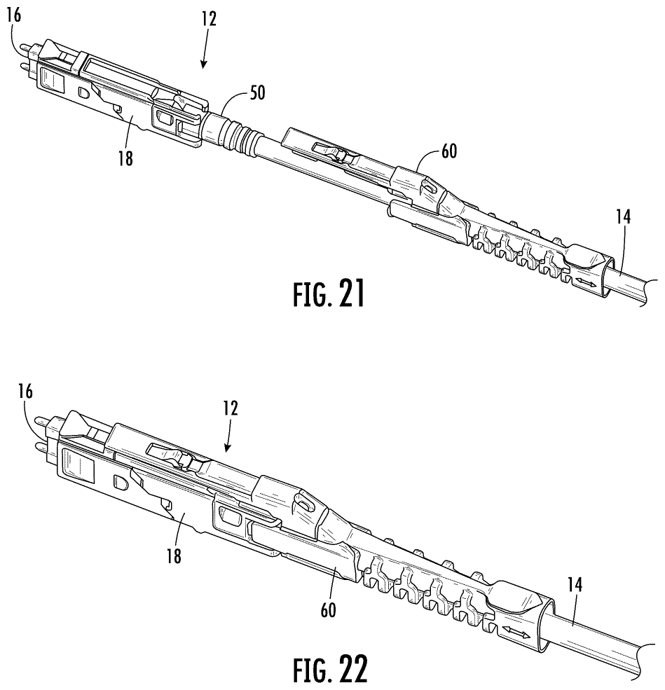

Once the cable 14 is permanently secured to the connector body 18, and as shown in FIGS. 21 and 22, the boot 60 may be moved forward from the cable 14 to couple to the connector body 18. The manner in which the coupling occurs depends on the particular design of the connector 12. In any event, this step may be the same as conventional cable assembly processes and need not be described further in this disclosure.

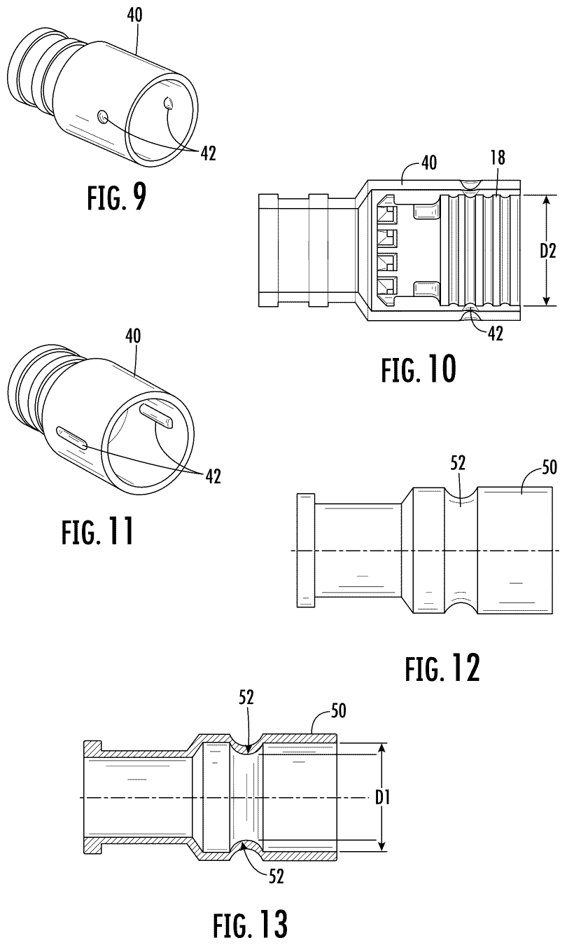

Instead, and as can be appreciated from the description above, methods according to this disclosure involve crimp bands having different designs than the crimp band 30. To this end, FIGS. 9 and 10 illustrate an example of a crimp band 40 according to another embodiment of this disclosure. In this embodiment, the first portion of the crimp band 40 includes two indents or radially-inward protrusions 42 that are symmetrically positioned about an axis of the crimp band 40. The protrusions 42 are shown in the form of round bumps on an inner surface of the crimp band 40, but other shapes are possible. For example, FIG. 11 illustrates an embodiment where the protrusions 42 are in the form of elongated bumps or ridges on the inner surface of the crimp band 40. The protrusions 42 are sized to provide the interference fit with the rear portion of the connector body 18. Although only two protrusions 42 are provided in the embodiment shown, in alternative embodiments there may be a different number of protrusions 42. Additionally, the protrusions 42 in other embodiments may be provided at different axial locations along the length of the crimp band 40, and the protrusions 42 at a given axial location need not necessarily be circumferentially arranged in an even manner (i.e., non-symmetrical arrangements are possible).

FIGS. 12 and 13 illustrate an example of a crimp band 50 according to yet another embodiment of this disclosure. In this embodiment, the first portion of the crimp band 50 includes an annular indent or circumferentially-extending, radially-inward ridge 52. The ridge 52, like the protrusions 42 (FIGS. 9-11), is sized to provide the interference fit with the rear portion of the connector body 18. To this end, the ridge 52 defines a diameter D1, which is the same or less than a maximum outer diameter D2 (FIG. 10) of the rear portion of the connector body 18.

More generally, the interference fit between crimp bands according to some embodiments of this disclosure (e.g., crimp bands 30, 40, 50) can be considered to have a minimum inner width in the portion of the crimp band that is eventually received over the rear portion of the connector body 18. The width may be considered as an inner diameter for crimp bands that are substantially cylindrical. The rear portion of the connector body 18, on the other hand, has a maximum outer width. The maximum outer width may be considered as an outer diameter for embodiments where the rear portion of the connector body 18 is substantially cylindrical. In some embodiments, the crimp band has a passage therethrough with a minimum inner width that is between about 0.25 mm and about 0.75 mm, and more preferably between about 0.35 mm and 0.55 mm, less than the maximum outer width of the rear portion of the connector body 18. Other embodiments, however, may involve a different amount of interference between the crimp band and rear portion of the connector body 18.

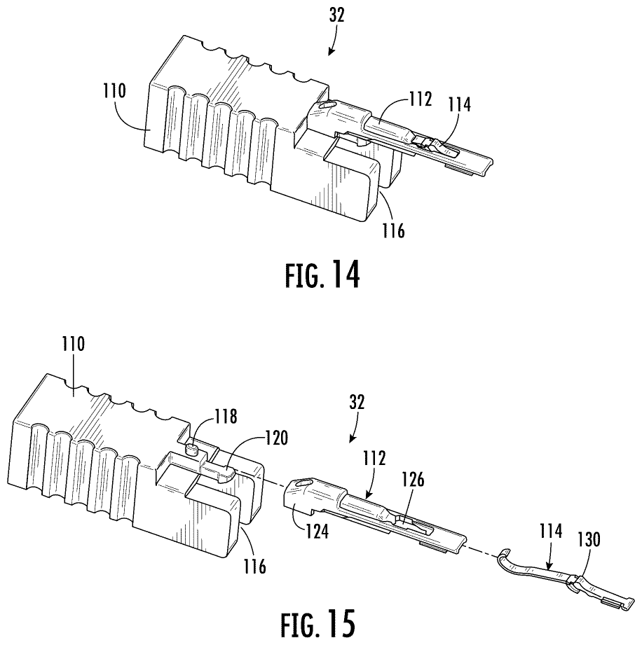

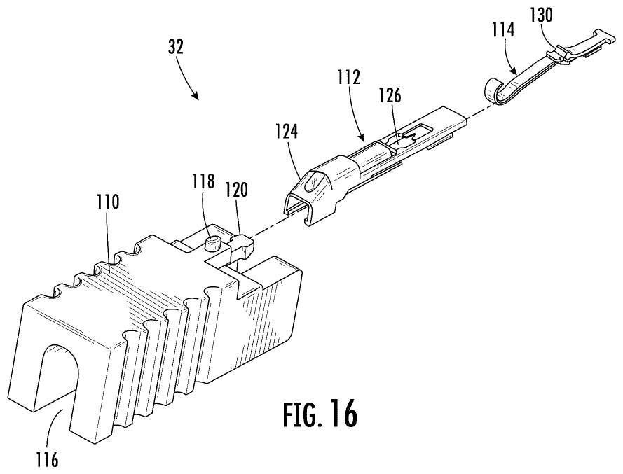

Now referring to FIGS. 14-16, an example embodiment of the positioning tool 32 will be described in further detail. FIG. 14 is a perspective view of the positioning tool 32 in an assembled configuration, whereas FIGS. 15 and 16 are exploded views showing various components of the positioning tool 32. The positioning tool 32 in the embodiment shown includes a main body member 110, an extension member 112 (also referred to as an arm member 112), and a latch body 114 (also referred to as a latch body 114). The main body member 110 is generally block-like/rectangular, but as mentioned above, may comprise a substantially U-shaped body. The U-shape is a result of a central receiving area or cavity 116 extending between opposite ends of the main body member 110 and being open along a bottom side of the main body member 110. The main body member 110 also includes a first coupling feature 118 for interfacing with the extension member 112 and, as will be described in further detail below, a second coupling feature 120 for interfacing with the connector body 18. The first coupling feature 118 allows the extension member 112 to couple to the main body member 110.

To this end, the extension member 112 includes a rear portion 124 configured to interface with main body member 110 and couple to the first coupling feature 118. The extension member 112 also includes an opening 126 configured to receive portions of the latch body 114. In the assembled configuration of the positioning tool 32 (FIG. 14), a latching portion 130 of the latch body 114 extends through the opening 126 of the extension member 112. The arrangement in the embodiment shown may be substantially similar to portions of the boot 60 (FIG. 1) that extend over a top side of the connector body 18. In other words, and for reasons that will be more apparent based on the description below, the extension member 112 and latch body 114 of the positioning tool 32 may be configured to mimic portions of the boot 60 of an MMC connector. An example boot configuration for an MMC connector is disclosed in U.S. Pat. No. 11,971,587 B2 (“the '587 patent”), the disclosure of such boot configuration being incorporated herein by reference.

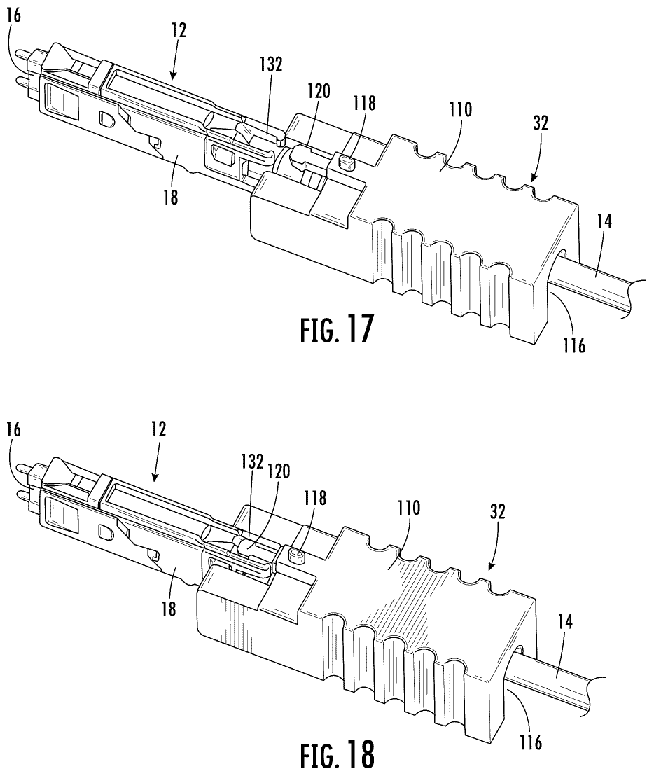

FIGS. 17 and 18 illustrate how the positioning tool 32 may be placed over the cable 14 and advanced forward to couple to the connector 12. The positioning tool 32 may be in an assembled configuration during these steps even though the extension member 112 (FIGS. 14-16) and latch body 114 are not shown in FIGS. 17 and 18. The latter two components of the positioning tool 32 are not shown to better illustrate interaction between the main body member 110 and the connector body 18. As mentioned above, the U-shaped configuration of the main body member 110 allows the positioning tool 32 to be placed over the cable 14 from a side of the cable 14. This results in the cable 14 being positioned in the receiving area 116 of the main body member 110. When the positioning tool 32 is advanced towards the connector body 18, the second coupling feature 120 engages a complementary coupling feature 132 on the connector body 18 to couple the positioning tool 32 to the connector body 18. This coupling may be substantially similar to how the boot 60 (FIG. 1) couples to the connector body 18, which is also described in the '587 patent.

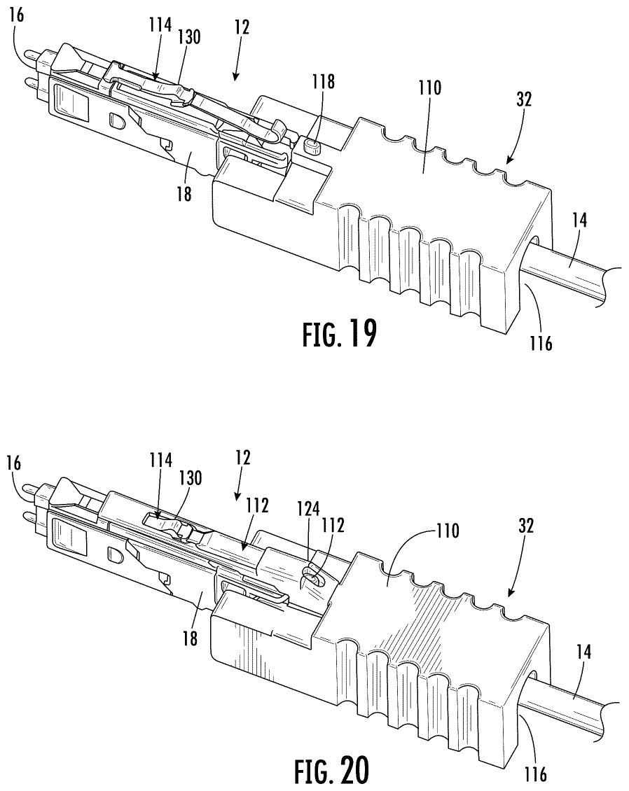

FIGS. 19 and 20 are similar to FIG. 18, but FIG. 19 adds the latch body 114 to the view and FIG. 20 adds the extension member 112. Again, these components may already be present due to the positioning tool 32 being in an assembled configuration. However, embodiments are also possible where the main body member 110 is first coupled to the connector body 18 without the extension member 112 and latch body 114 being present, with the latter two components thereafter being assembled with the main body member 110. The configuration of the components of the positioning tool 32 and how and/or when they are assembled may vary. Indeed, as mentioned above, the positioning tool 32 is merely one example to illustrate optional aspects of this disclosure. Moreover, more important to this disclosure is the general principle that the positioning tool 32 may ultimately be coupled to the connector body 18 and includes portions (e.g., extension member 112 and latch body 114) that are intended to function in a manner similar to portions of the boot 60 (FIG. 1). Such a feature has the advantage of allowing the positioning tool 32 to interface with equipment already designed for the connector 12. For example, the positioning tool 32 may be configured to couple the connector 12 to test equipment (not shown) that is normally used for inspecting the connector 12 after the boot 60 is assembled. Alternatively or additionally, the positioning tool 32 may be configured to couple the connector 12 to processing equipment (e.g., polishing equipment, cleaving equipment, etc.; not shown) normally used after the boot 60 is assembled with the connector 12, or fixtures for such equipment. This may allow re-work steps to be performed more efficiently.

Once a technician and/or machine determines that no re-work steps (or further re-work steps) are needed during a termination process, the positioning tool 32 may be de-coupled from the connector body 18 and removed from the cable 14. Then, as shown in FIGS. 21 and 222, the boot 60 may be advanced towards and coupled to the connector body 18. As mentioned above, the boot 60 is slid onto the cable 14 earlier in the cable assembly process, before securing the optical fibers to the ferrule 16 of the connector 12.

Many advantages and modifications will readily appear to those skilled in the art. For example, although the examples described above refer to a fiber optic connector, the principles of this disclosure may apply to other connectors for other signal conductors, such as copper connectors for copper wire conductors in copper telecommunication cables. Indeed, the present disclosure in its broader aspects is not limited to the specific details, representative apparatus, and methods and illustrative examples shown and described. Departures may be made from such details without departing from the scope of the present disclosure.

What is claimed is:

1. A method of making a fiber optic cable assembly from a cable and a connector, wherein the cable includes a cable jacket, at least one optical fiber carried within the cable jacket, and aramid yarn carried within the cable jacket, and wherein the connector includes a ferrule and a connector body, the method comprising:
positioning a crimp band over an end portion of the cable jacket;
terminating the at least one optical fiber with the ferrule after positioning the crimp band, wherein the at least one optical fiber extends from an end of the cable jacket before the terminating;
assembling the connector body with the ferrule before or after the terminating step;
positioning at least some length of aramid yarn that extends from the end of the cable jacket over a rear portion of the connector body;
moving the crimp band over the rear portion of the connector body after the preceding steps such that the at least some length of the aramid yarn is positioned between the crimp band and the rear portion of the connector body, wherein the crimp band is configured to have an interference fit with the rear portion of the connector body without being crimped such that the moving results in the crimp band securing the at least some length of aramid yarn to the rear portion of the connector body;
performing one or more additional processing steps while the at least some length of aramid yarn remains secured to the rear portion of the connector body by the interference fit with the crimp band;
determining that a re-work of the assembling step or any of the one or more additional processing steps is needed before crimping the crimp band over the rear portion of the connector body;
removing the crimp band from the rear portion of the connector body and performing the re-work; and
crimping the crimp band over the rear portion of the connector body after performing the re-work.

2. The method of claim 1, further comprising:
coupling a positioning tool to the connector body after the moving step results in the crimp band securing the at least some length of aramid yarn to the rear portion of the connector body, wherein the positioning tool is configured to interface with: (a) equipment used to perform the one or more additional processing steps; and/or (b) test equipment used to inspect the connector as part of the determining step.

3. The method of claim 2, wherein the positioning tool defines a latch member that is positioned over a top side of the connector body when the positioning tool is coupled to the connector body.

4. The method of claim 2, wherein the removing the crimp band step further comprises:
moving the positioning tool away from the connector body such that the positioning tool decouples from the connector body.

5. The method of claim 4, wherein the positioning tool is configured to cause the crimp band to move with the positioning tool away from the connector body.

6. The method of claim 1, wherein the one or more additional processing steps comprises polishing an end face of the ferrule, and wherein the re-work comprises re-polishing the end face of the ferrule.

7. The method of claim 1, wherein the re-work comprises:
disassembling the connector at least partially;
changing a gender configuration of the ferrule by adding or removing one or more guide pins that are each configured to extend through the ferrule; and
re-assembling the connector.

8. The method of claim 1, wherein the crimp band includes a passage extending therethrough and a first portion configured to provide the interference fit with the rear portion of the connector body, and wherein the passage defines a minimum inner width in the first portion that is between about 0.25 mm and about 0.75 mm less than a maximum outer width of the rear portion of the connector body.

9. The method of claim 1, wherein the crimp band is tubular and includes one or more radially-inward projections configured to provide the interference fit with the rear portion of the connector body.

10. The method of claim 9, wherein the one or more radially-inward projections comprises a radially-inward, annular projection at a location along a length of the crimp band.

11. A method of making a fiber optic cable assembly from a cable and a connector, wherein the cable includes a cable jacket, at least one optical fiber carried within the cable jacket, and aramid yarn carried within the cable jacket, and wherein the connector includes a ferrule and a connector body, the method comprising:
positioning a crimp band over an end portion of the cable jacket;
securing the at least one optical fiber to the ferrule after positioning the crimp band, wherein the at least one optical fiber extends from an end of the cable jacket before the securing;
assembling the connector body with the ferrule before or after the securing step;
positioning at least some length of aramid yarn that extends from the end of the cable jacket over a rear portion of the connector body;
moving the crimp band over the rear portion of the connector body after the preceding steps such that the at least some length of aramid yarn is positioned between the crimp band and the rear portion of the connector body, wherein the crimp band is configured to have an interference fit with the rear portion of the connector body without being crimped such that the moving results in the crimp band securing the at least some length of aramid yarn to the rear portion of the connector body;
inspecting the connector while the at least some length of aramid yarn remains secured to the rear portion of the connector body by the interference fit with the crimp band;
identifying that one or more additional processing steps or assembly steps is required based on the inspecting;
removing the crimp band from the rear portion of the connector body and performing the one or more additional processing steps or assembly steps that were identified; and
crimping the crimp band over the rear portion of the connector body after performing the one or more additional processing steps or assembly steps that were identified.

12. The method of claim 11, further comprising:
coupling a positioning tool to the connector body after the moving step results in the crimp band securing the at least some length of aramid yarn to the rear portion of the connector body, wherein the positioning tool is configured to interface with test equipment for the inspecting.

13. The method of claim 12, wherein the positioning tool defines a latch member that is positioned over a top side of the connector body when the positioning tool is coupled to the connector body.

14. The method of claim 12, wherein the removing the crimp band step further comprises:
moving the positioning tool away from the connector body such that the positioning tool decouples from the connector body.

15. The method of claim 14, wherein the positioning tool is configured to cause the crimp band to move with the positioning tool away from the connector body.

16. The method of claim 11, wherein the one or more additional processing steps or assembly steps comprises polishing an end face of the ferrule.

17. The method of claim 11, wherein the one or more additional processing steps or assembly steps comprises:
disassembling the connector at least partially;
changing a gender configuration of the ferrule by adding or removing one or more guide pins that are each configured to extend through the ferrule; and
re-assembling the connector.

18. The method of claim 11, wherein the crimp band includes a passage extending therethrough and a first portion configured to provide the interference fit with the rear portion of the connector body, and wherein the passage defines a minimum inner width in the first portion that is between about 0.25 mm and about 0.75 mm less than a maximum outer width of the rear portion of the connector body.

19. The method of claim 11, wherein the crimp band is tubular and includes one or more radially-inward projections configured to provide the interference fit with the rear portion of the connector body.

20. A method of making a telecommunications cable assembly from a cable and a connector, wherein the cable carries at least one signal conductor, the method comprising:
positioning a crimp band over a cable jacket of the cable;
terminating the at least one signal conductor with the connector, wherein the crimp band is spaced from the connector during the terminating, and wherein an end section of the at least one signal conductor extends from an end of the cable jacket before the terminating;
positioning at least some amount of strength members of the cable over a rear portion of the connector;
moving at least a first portion of the crimp band over the rear portion of the connector after the terminating step and after the step of positioning at least some amount of the strength members, wherein the first portion of the crimp band is configured to have an interference fit with the rear portion of the connector without being crimped such that the moving results in the crimp band initially securing the at least some amount of the strength members to the connector;
performing one or more additional processing steps while the crimp band remains uncrimped and the cable remains initially secured to the connector by the crimp band;
determining that a re-work of at least one of the one or more processing steps is required;
removing the crimp band from the connector so that the cable is no longer initially secured to the connector;
performing the re-work; and
permanently securing the cable to the connector using the crimp band, wherein the crimp band is crimped to permanently secure the cable to the connector.
